(19) United States
(12) Patent Application Publication
(10) Pub. No.: US 2026/0024076 A1
(43) Pub. Date: Jan. 22, 2026

(54) ENHANCED RECIPIENT NOTIFICATION

(71) Applicant: VISA INTERNATIONAL SERVICE ASSOCIATION, San Francisco, CA (US)

(72) Inventors: Jarkko Oskari Sevanto, Berkeley, CA (US); Shivam Tickoo, San Francisco, CA (US); Gwen Ma, Belmont, CA (US); Brandon Haenlein, Parker, CO (US); Dmitri Bannikov, Mountain View, CA (US)

(73) Assignee: VISA INTERNATIONAL SERVICE ASSOCIATION, San Francisco, CA (US)

(21) Appl. No.: 18/993,504

(22) PCT Filed: Jul. 18, 2023
(86) PCT No.: PCT/US2023/070379

§ 371 Date: Jan. 10, 2025

Related U.S. Application Data
(60) Provisional application No. 63/390,287, filed on Jul. 18, 2022.

(51) Int. Cl. G06Q 20/36; G06Q 20/38

(52) U.S. Cl. CPC G06Q 20/36; G06Q 20/3821

(57) ABSTRACT

Embodiments allow for a first transfer application executing on a first user device to send funds to a second transfer application executing on a second user device along with supplemental data. The supplemental data includes one or more of a text message, an audio content, a video content, a drawing, a photograph, a multimedia file, and the like. The application provider server of the first transfer application and/or the application provider server of the second transfer application does not support transfer of the supplemental data. A processing computer positioned between the two transfer applications facilitates the transfer of supplemental data. When the funds transfer is processed by an authorizing entity, the processing computer generates an enhanced notification including the supplemental data, and transmits the enhanced notification directly to the second transfer application.

### CROSS-REFERENCES TO RELATED APPLICATIONS

This application is a PCT application, which claims priority to and the benefit of U.S. Provisional Patent Application No. 63/390,287, filed on Jul. 18, 2022, which is herein incorporated by reference.

### BACKGROUND

Many transfer applications allow users of the application (e.g., senders) to easily transact with other users of a different application (e.g., recipients). Upon a successful transaction, the transfer application of the recipient can receive a transaction data regarding the transaction. However, the transaction data received by the transfer application of the recipient is often limited, receiving only basic payment data such as transaction amount and date. Therefore, even if the sender sends other supplemental data (e.g., sender's message) regarding the transaction, the recipient would not be able to receive such data.

Embodiments of the disclosure address this problem and other problems individually and collectively.

### SUMMARY

Embodiments allow a sender using a first transfer application executing on a sender's user device to send funds as well as supplemental data to a recipient using a second transfer application executing on a recipient's user device, where the second transfer application does not support transmission of supplemental data (e.g., text message, audio file, video file, multimedia file, photo, etc.). Embodiments provide a processing server for receiving and storing the supplemental data from the sender via the first transfer application. The processing server operates with an authorizing entity to complete the funds transfer using OCT processing. Once the OCT processing is approved by the authorizing entity, the processing computer generates and transmits an enhanced notification message to the second transfer application installed on the recipient's user device. The enhanced notification message informs the recipient of the funds transfer along with the supplemental data provided by the sender. The second transfer application outputs the supplemental data on the recipient's user device.

Embodiments provide a method, performed by a processing computer. The method comprises receiving, from a digital wallet provided on a first user device, a processing request message comprising supplemental data and transaction data elements regarding a transaction between a first user operating the first user device and a second user operating a second user device. The processing computer stores, in a database, the supplemental data as being associated with the transaction data elements; and transmits, to an authorizing entity computer holding an account of the second user, a push request message comprising the transaction data elements without the supplemental data. The push request message conforms to a format that the authorizing entity is configured to process. The method further includes receiving, from the authorizing entity computer, a push response message comprising the transaction data elements. The processing computer searches the database for the supplemental data using one or more of the transaction data elements received in the push response message, and identifies the supplemental data in the database based on a match between the one or more of the transaction data elements received in the push response message with one or more of transaction data elements stored on the database. The method also includes retrieving the supplemental data corresponding to matched transaction data elements; generating a notification message comprising the supplemental data; and transmitting the notification message comprising the supplemental data to a digital wallet provided on the second user device. The supplemental data is output on the second user device in connection with a notification associated with the transaction.

Embodiments further provide a system comprising a processing computer comprising one or more processors; and a non-transitory computer readable medium comprising code executable by the one or more processors for performing the method described above.

According to various embodiments, a method comprises receiving, by a first digital wallet application executing on a first user device from a processing computer, a notification message comprising supplemental data and an outcome of a transfer transaction. A digital wallet provider server managing the first digital wallet is unable to support transmission of supplemental data. The first digital wallet application displays a graphical user interface to display the outcome of the transfer transaction; and outputs the supplemental data along with displaying the outcome of the transfer transaction, wherein supplemental data comprises one or more of text data, image data, audio data, multimedia data, or data embedded in machine readable code.

A better understanding of the nature and advantages of embodiments of the invention may be gained with reference to the following detailed description and accompanying drawings.

### BRIEF DESCRIPTION OF THE DRAWINGS

FIG. 1 illustrates two user devices storing one or more applications interacting over a processing computer, according to various embodiments.

FIG. 2 illustrates a flow diagram of transmitting transaction data and supplemental data from a first transfer application to a second transfer application over a processing computer, according to various embodiments.

FIG. 3 illustrates another flow diagram of transmitting transaction data and supplemental data from a first transfer application to a second transfer application over a processing computer, according to various embodiments.

FIG. 4 illustrates an exemplary graphical user interface of a transfer application executing on a user device and outputting supplemental data in connection with a transaction, according to various embodiments.

FIG. 5 illustrates another exemplary graphical user interface of a transfer application executing on a user device and outputting supplemental data in connection with a transaction, according to various embodiments.

FIG. 6 illustrates an exemplary graphical user interface of a transfer application executing on a user device including exemplary visual cues for indicating supplemental data received in connection with a transaction, according to various embodiments.

FIG. 7 illustrates a block diagram of an exemplary user device, according to various embodiments.

FIG. 8 illustrates a block diagram of an exemplary processing computer, according to various embodiments.

### DETAILED DESCRIPTION

Embodiments allow for a first digital wallet (e.g., a first transfer application) executing on a first user device to send funds to a second digital wallet (e.g., a second transfer application executing on a second user device) along with supplemental data. For example, the supplemental data may include one or more of a text message, an audio content, a video content, a drawing, a photograph, a multimedia file etc. The supplemental data may be created on the first user device. According to various embodiments, the first digital wallet and the second digital wallet are managed by different wallet provider servers. The wallet provider server of the first digital wallet and/or the second digital wallet does not support transfer of the supplemental data. According to various embodiments, a processing computer positioned between the two transfer applications (as well as the two wallet provider servers) facilitates the transfer of the supplemental data along with the funds. When the funds transfer is processed by an authorizing entity, the processing computer generates an enhanced notification that includes the supplemental data and the transaction data. The processing computer transmits the enhanced notification to the second digital wallet, bypassing the wallet provider of the second digital wallet that may not support transmission of the supplemental data.

In some embodiments, the first digital wallet executing on the sender's user device may receive a digital tag of the recipient. The digital tag may represent a credential associated with the recipient. For example, the digital tag may be linked to a previously issued credential, such as a payment credential or a virtual credential issued by an authorizing entity. Prior to contacting the processing computer regarding the funds transfer request (e.g., transaction), the first digital wallet may transmit a message to a digital tag computer requesting the credential associated with the digital tag. The digital tag computer may return the credential to the first transfer application. The first transfer application may then generate a transfer request message including transfer data, the credential of the recipient, and the supplemental data. The transfer request message may also include a digital tag or other credential of the sender.

Prior to discussing embodiments of the disclosure, some terms can be described in further detail.
A “user” may include an individual. In some embodiments, a user may be associated with one or more personal accounts and/or mobile devices. The user may also be referred to as a cardholder, account holder, or consumer in some embodiments. A first user may be referred as a sender who may send funds to a second user, who may be referred as a recipient.
A “user device” may be any suitable device that a user can interact with (e.g., a payment card, a mobile phone, a smart device). User devices may be in any suitable form. Some examples of user devices include cards (e.g., payment cards such as credit, debit, or prepaid cards) with magnetic stripes or contactless elements (e.g., including contactless chips and antennas), cellular phones, PDAS, personal computers (PCs), tablet computers, wearable devices, and the like. In some embodiments, where a user device is a mobile device, the mobile device may include input means (e.g., a camera, a microphone, etc.), output means (e.g., a display, speakers, vibration mechanism, etc.), a memory, a processor, a computer-readable medium, and any other suitable component.
An “authorizing entity” may be an entity that authorizes a request. Examples of an authorizing entity may be an issuer, a governmental agency, a document repository, an access administrator, etc. An “issuer” may typically refer to a business entity (e.g., a bank) that maintains an account for a user. An issuer may also issue payment credentials stored on a user device, such as a cellular telephone, smart card, tablet, or laptop to the consumer.
A “mobile device” (sometimes referred to as a mobile communication device) may comprise any suitable electronic device that may be transported and operated by a user, which may also provide remote communication capabilities to a network. A mobile communication device may communicate using a mobile phone (wireless) network, wireless data network (e.g., 3G, 4G or similar networks), Wi-Fi, Bluetooth, Bluetooth Low Energy (BLE), Wi-Max, or any other communication medium that may provide access to a network such as the Internet or a private network. Examples of mobile devices include mobile phones (e.g., cellular phones), PDAs, tablet computers, net books, laptop computers, wearable devices (e.g., watches), vehicles such as automobiles and motorcycles, personal music players, hand-held specialized readers, etc. A mobile device may comprise any suitable hardware and software for performing such functions, and may also include multiple devices or components (e.g., when a device has remote access to a network by tethering to another device-i.e., using the other device as a modem-both devices taken together may be considered a single mobile device).
A “digital wallet” can include an electronic device that allows an individual to conduct electronic commerce transactions. A digital wallet may store user profile information, payment credentials, bank account information, one or more digital wallet identifiers and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. A digital wallet may be designed to streamline the purchase and payment process. A digital wallet may allow the user to load one or more payment cards onto the digital wallet to make a payment without having to enter an account number or present a physical card. A digital wallet may be a transfer application.
A “token” may be a substitute value for a credential. A token may be a string of numbers, letters, or any other suitable characters. Examples of tokens include payment tokens, access tokens, personal identification tokens, etc.
A “payment token” may include an identifier for a payment account that is a substitute for an account identifier, such as a primary account number (PAN). For example, a payment token may include a series of alphanumeric characters that may be used as a substitute for an original account identifier. For example, a token “4900 0000 0000 0001” may be used in place of a PAN “4147 0900 0000 1234.” In some embodiments, a payment token may be “format preserving” and may have a numeric format that conforms to the account identifiers used in existing transaction processing networks (e.g., ISO 8583 financial transaction message format). In some embodiments, a payment token may be used in place of a PAN to initiate, authorize, settle or resolve a payment transaction or represent the original credential in other systems where the original credential would typically be provided. In some embodiments, a payment token may be generated such that the recovery of the original PAN or other account identifier from the token value may not be computationally derived. Further, in some embodiments, the token format may be configured to allow the entity receiving the token to identify it as a token and recognize the entity that issued the token.
“Tokenization” is a process by which data is replaced with substitute data. For example, a payment account identifier (e.g., a primary account number (PAN)) may be tokenized by replacing the primary account identifier with a substitute number (e.g., a token) that may be associated with the payment account identifier. Further, tokenization may be applied to any other information that may be replaced with a substitute value (i.e., token). Tokenization enhances transaction efficiency and security.
A “digital tag” may be a unique identifier used to facilitate transfers. A digital tag may be a set of alphanumeric characters to be associated with a user. The digital tag may be a payment tag that point to a virtual credential issued by an authorizing entity and linked to an account registered with a peer-to-peer application. The virtual credential may be in the form of a real payment credential, but unlike a real payment credential, it cannot be used to independently conduct payment transactions.
A “transfer application” (e.g., a peer-to-peer application, a digital wallet application, etc.), accessed (e.g., installed, accessed via a web browser, etc.) by a user operating a user device, may allow users of the application to send, receive, or request transfers from other users of the application. The transfer application may be maintained, managed and/or provided by an application provider server. For example, a first user may use a transfer application on their user device to generate a transfer request (e.g., a request receive $20 USD from a second user, a request for data from a second user). The transfer request may comprise a transfer amount, and an alias associated with a second user. The alias may be a digital tag, which uniquely identifies the second user across different transfer applications via a digital tag computer. In some embodiments, the digital tag may be a payment tag and the digital tag computer may be a payment tag service computer. The digital tag may be issued by an authorizing entity and registered with the digital tag computer to be used in transfers.

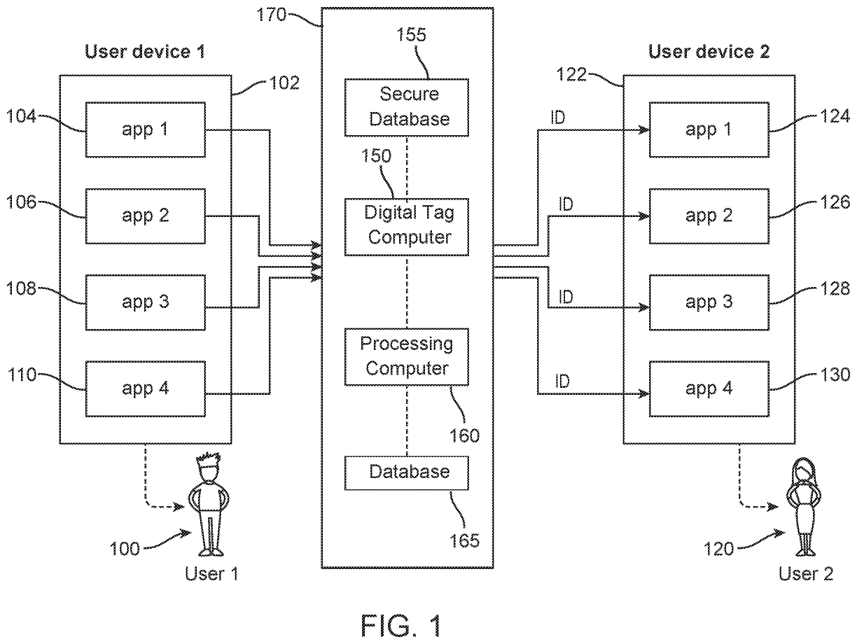

FIG. 1 illustrates two user devices each storing one or more applications interacting over a processing computer, according to various embodiments. In an exemplary person-to-person funds transfer method, a first user 100 (e.g., sender) may choose to send funds to a second user 120 (e.g., recipient). The first user 100 may choose one of a plurality of transfer applications 104, 106, 108, 110 (e.g., one of a plurality of digital wallets) installed on the first user device 102 to conduct the transaction (e.g., transfer the funds). The second user may choose one of the plurality of transfer applications 124, 126, 128, 130 (e.g., one of a plurality of digital wallets) installed on the second user device 122 to receive the funds. The first transfer application 104 used by the first user 100 may be different than the second transfer application 124 used by the second user 120. That is, the first transfer application 104 used by the first user 100 may be provided and/or managed by a first application provider server, which is different than a second application provider server managing the second transfer application 124 used by the second user 120.

In some embodiments, the transaction may be streamlined by using a digital tag. The first transfer application 104 of the first user 100 may receive a digital tag of the second user 120. The first transfer application 104 may provide the digital tag to a digital tag computer 150, that may retrieve a credential associated with the digital tag from a secure database 155. The digital tag computer 150 may return the credential (for the second user 120) to the first transfer application 104.

In some embodiments, the digital tag computer 150 and the processing computer 160 may be part of a same transaction processing network 170, or may be managed by a same entity. The digital tag computer 150 and the processing computer 160 may exchange messages or data over an internal communication network, via proprietary APIs, etc.

The first user 100 may launch the first transfer application 104 on the first user device 102. The first user 100 may enter transaction data such as the recipient's account identifier or digital tag, and the amount to be transferred to the first transfer application 104. The first transfer application 104 may allow the first user 100 to generate supplemental data that can be sent with the funds transfer. For example, the first user 100 may create a text message, an audio recording, a video message, etc. using the first user device in connection with the transfer request.

During the transfer transaction, the first transfer application 104 of the first user 100 may transmit an enhanced transfer message comprising the transaction data and the supplemental data to a processing computer 160. The supplemental data may include one or more of a text message, an audio file, a video file, a photograph, a multimedia file etc. generated on the first user device 102, by the first user 100. For example, the supplemental data may be generated by using input means (e.g., camera, microphone, physical or digital keyboard) of the first user device 102. The processing computer 160 may retrieve the supplemental data from the enhanced transfer message, and store the supplemental data as being associated with elements of the transaction data at a database 165. The processing computer 160 may later be able to identify the supplemental data upon querying the database 165 with one or more elements of the transaction data. Upon storing the supplemental data at the database 165, the processing computer 160 may return a confirmation message to the first transfer application 104 indicating the supplemental data has been received and stored, and that the first transfer application 104 may proceed with the transfer transaction.

After receiving the confirmation message from the processing computer 160, the first transfer application 104 may transmit a transfer message including only the transfer data (and not the supplemental data) to a transport computer (e.g., a bank of the first user 100). The transport computer can then generate a push request message (e.g., Original Credit Transaction (OCT) message) comprising the transaction data, and send the push request message to an authorizing computer (e.g., a bank of the second user) through the processing computer, where the authorizing computer can notify the second transfer application 124 of the second user 120 of the transaction data inside the push request message. The authorizing computer also notifies the processing computer 160, which then fetches the supplemental data, and transmits the supplemental data along with the transfer data to the second transfer application 124.

In some cases, the push request message has a predetermined format, and can only store the transaction data, and not supplemental data (e.g., arbitrary sender messages) due its size and formatting requirements. For example, the push request message may only store the transaction data such as the transaction amount, the date, and the name of the receiving user.

In embodiments of the invention, the second transfer application 124 of the second user 200 may receive both the transaction data and supplemental data in a transaction such as a funds transfer transaction. For example, upon authorization of the transaction by the authorizing computer, the processing computer 160 can receive a notification from the authorizing computer regarding the authorization of the transaction, along with the transaction data. The processing computer 160 may then query the database 165 using one or more elements of the transaction data to identify the supplemental data. The processing computer 160 may retrieve the supplemental data from the database 165, and generate an enhanced notification message comprising the transaction data and the supplemental data. The processing computer 160 may transmit the enhanced notification message to the second transfer application 124 of the second user 120. The supplemental data may then be output on the second user device 122 through the second transfer application 124. The second user 120 can access both the transaction data and the supplemental data on the second user device 122.

In some embodiments, the processing computer 160 may assign tag or an identifier to a transaction after storing the supplemental data at the database 165. The tag or the identifier may be then used to locate the supplemental data associated with the transaction. The identifier may be inserted in a data field of the messages exchanged between the processing computer 160, the first transfer application 104, the second transfer application 124, the transport computer and/or the authorizing computer.

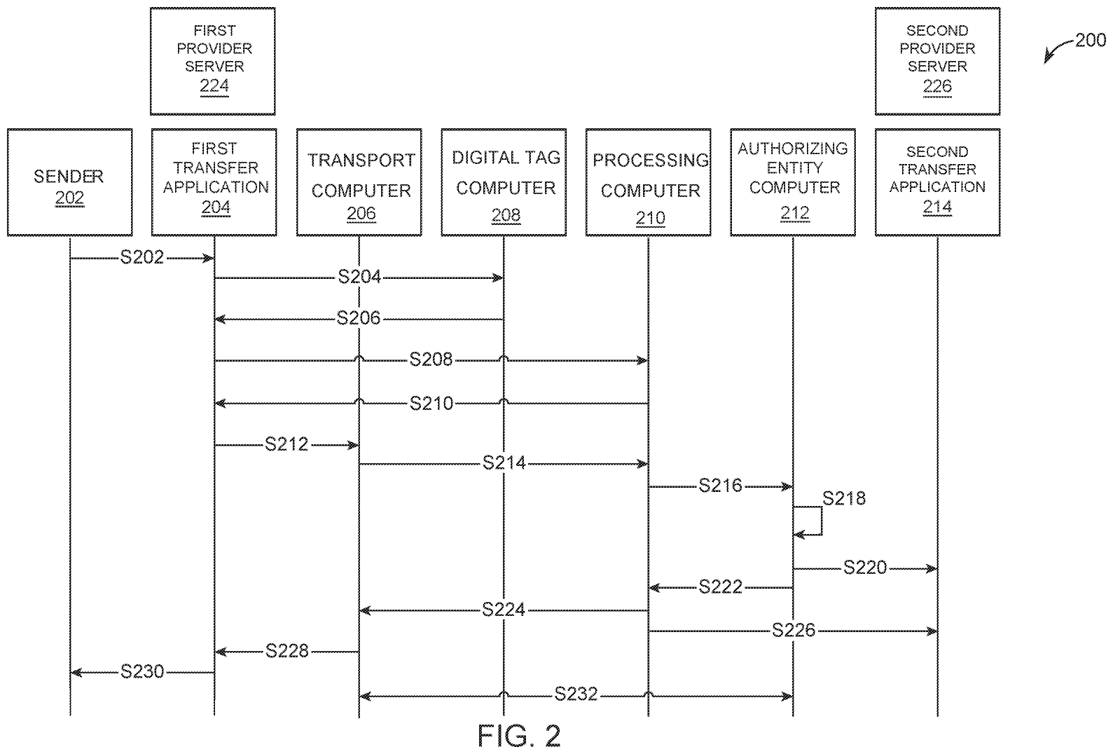

FIG. 2 illustrates a flow diagram of transmitting transaction data and supplemental data from a first transfer application to a second transfer application over a processing computer, according to various embodiments. A sender 202, a first transfer application 204 managed by a first application provider server 224, a transport computer 206, a digital tag computer 208, a processing computer 210, an authorizing entity computer 212, and a second transfer application 214 managed by a second application provider server 226 are shown, and are in operative communication with each other. The first transfer application 204 may be installed and execute on a first user device of the sender 202, and the second transfer application 214 may be installed and execute on a second user device of a recipient.

In some embodiments, the first transfer application 204 (e.g., digital wallet) may be associated (e.g., via API connectivity) with the processing computer 210. The first transfer application 204 may also be associated with the transport computer 206 (e.g., an acquirer bank), and may be in communication with the first application provider server computer 224 (e.g., a first digital wallet server). The recipient (e.g., a second user), and the second transfer application 214 (e.g., digital wallet) may be associated with the authorization computer 212 (e.g., an issuer bank). The authorization computer 212 may operate the second application provider server 226 (e.g., a second digital wallet server) associated with the second transfer application 214. In some embodiments, the second application provider server 226 may be operated by an entity different than the entity operating the authorization computer 212. The digital tag computer 208 and the processing computer 210 may be operated by the same entity or may be present in the same transaction processing network 170.

In step S202, the sender 202 can initiate a person-to-person fund transfer by entering an account identifier, such as a digital tag, of a recipient in the first transfer application 204 executing on the user device of the sender 202. Embodiments are not limited to the use of digital tags, and may work the same with different types of account identifiers such as primary account numbers (PANs), payment tokens, and the like. The person-to-person fund transfer is used to send a payment to the recipient. The sender 202 may enter other transaction data such as transaction amount, and supplemental data into the first transfer application 204. The supplemental data may include arbitrary content generated by the sender 202. For example, the supplemental data may include one or more of a text message, an audio file, a video file, a drawing, a photograph, a multimedia file, etc.

According to some embodiments, when the transaction data is entered in the first transfer application 204, the first transfer application 204 may prompt the user to create and/or add supplemental data to the transfer request. The first transfer application 204 may guide the user to create and associate the supplemental data with the transaction data through one or more GUIs.

When the digital tag is used, the recipient may have registered the digital tag with the digital tag computer 208 prior to the transaction. The digital tag can be linked to a payment credential (primary account number) or a payment token in a database (e.g., secure database 155) accessible by the digital tag computer 208. In some embodiments, the secure database 155 may only be accessible by the digital tag computer 208.

Steps S204-S206 may be performed when the transaction data entered into the first transfer application 204 includes a digital tag.

In step S204, the first transfer application 104 can send the digital tag to the digital tag computer 150.

The digital tag computer may store a mapping between a digital tag of the second user and a credential associated with second user. In step S206, upon receiving the digital tag, the digital tag computer 208 can identify the credential at the secure database, and retrieve the credential from the secure database. The digital tag computer 208 may then transmit the credential to the first transfer application 204 provided on the first user device.

In step S208, the first transfer application 204 can send a first message (e.g., a processing request message, enhanced transaction request message) comprising the transaction data elements and the supplemental data regarding the transaction to the processing computer 210. The transaction data elements may comprise one or more of the payment token or payment credential associated with the second user (e.g., including the credential retrieved from the digital tag computer or any other credential associated with an account of the second user), sender's account identifier (e.g., sender's digital tag or other account identifier), sender's reference number, acquiring Bank Identification Number (BIN) and/or Merchant Verification Value (MVV), date and time of the transaction, etc. The supplemental data may include one or more of the sender's note (e.g., “Thanks for the dinner!”), an audio file, a video file, a drawing, a photograph, a multimedia file or data embedded in machine readable code, which may be arbitrary in nature.

In step S210, the processing computer 210 may parse the processing request message (e.g., the enhanced transaction request message) to identify one or more fields storing data. The processing computer 210 may identify a data field storing the supplemental data, and one or more data fields storing the transaction data. The processing computer 210 retrieve the supplemental data to store the supplemental data as being associated with the transaction data elements at the database. The processing computer 210 stores the transaction data elements and the supplemental data as being associated with the transaction data elements in the database. The processing computer 210 transmits a confirmation message to the first transfer application 204 confirming the receipt of the supplemental data and the transaction data elements. In some embodiments, the confirmation message excludes the supplemental data, which is now stored at the database.

In some embodiments, a push request message for transferring the funds indicated in the processing request message to the recipient account may be generated by a transport computer, and transmitted to the processing computer 210. Steps S212-S214 capture these steps.

In step S212, the first transfer application 204 can work with the transport computer 206 to generate a transfer request message in an API format, and send the transfer request message in API format to the processing computer 210. Step S212 may not be initiated prior to the first transfer application 204 receiving the confirmation message from the processing computer 210 confirming the receipt of the supplemental data and the transaction data elements. For example, the receipt of the confirmation message from the processing computer 210 may be a prerequisite to the first transfer application 204 initiating the process to generate the push request message.

In step S214, the transport computer 206 can generate the push request message. The push request message may be in ISO 8583 format. In some embodiments, the push request message may be an original credit transaction (OCT) request message. The push request message may include the transaction data elements. The supplemental data elements may not be included in the push request message due to size limitation and industry standard format of the push request message (e.g., ISO 8583 format does not allow for, or does not include data fields to accept supplemental data as described herein). For example, the sender's note may be too large to store in ISO format. The push request message (not including the supplemental data) can be sent from the transport computer 206 to the processing computer 210.

In step S216, the processing computer 210 can validate the push request message. If the sender's account credential is a payment token, the processing computer 210 detokenizes the payment token to obtain the payment credential. If the first user's credentials include a digital tag, the processing computer 210 can communicate with the digital tag computer 208 to obtain the account credential for the first user (e.g., the sender 202). The digital tag computer 208 may store at the second database a mapping between the digital tag of the first user and a credential associated with the first user. The digital tag computer 208 may identify the credential at the secure database, retrieve the credential from the secure database, and transmit the credential to the processing computer 210. Later, the transaction is settled using funds debited to an account associated with the credential of the first user.

The push request message may confirm to a format that the authorizing entity is configured to process. The format may not include a data field configured to store or transmit the supplemental data. For example, the push request message may be in ISO format. In some embodiments, the push request message may be OCT authorization request message. In some embodiments, the processing computer 210 may also generate a unique identifier (e.g., a transaction ID) for the transaction and may include unique identifier in the push request message transmitted to the authorizing entity computer 212. The push request message may comprise the payment credential, the unique identifier, the transaction data elements, but not the supplemental data. The supplemental data may also be stored at the database as being associated with the unique identifier. The processing computer 210 can then send the push request message to the authorizing entity computer 212.

In step S218, the authorizing entity computer 212 can validate the push request message, and authorize the transaction.

In step S220, upon authorizing the transfer, the authorizing entity computer 212 can credit the recipient's account associated with the second transfer application 214 of the transaction and advise the second transfer application 214 of the payment transfer.

In step S222, the authorizing entity computer 212 can generate a push response message. The push response message can comprise an indication of the funds being deposited at the recipient's account, the unique identifier (if applicable), and the transaction data elements. The authorizing entity computer 212 can send the push response message to the processing computer 210. The push response message may be in ISO format. In some embodiments, the push response message may be OCT authorization response message.

In step S224, the processing computer 210 can generate a transfer response message (e.g., a transfer complete notification message) comprising elements of the push response message. The transfer response message may be in ISO format. In some embodiments, the transfer response message may be OCT response message. The processing computer 210 may transmit the transfer response message to the transport computer 206.

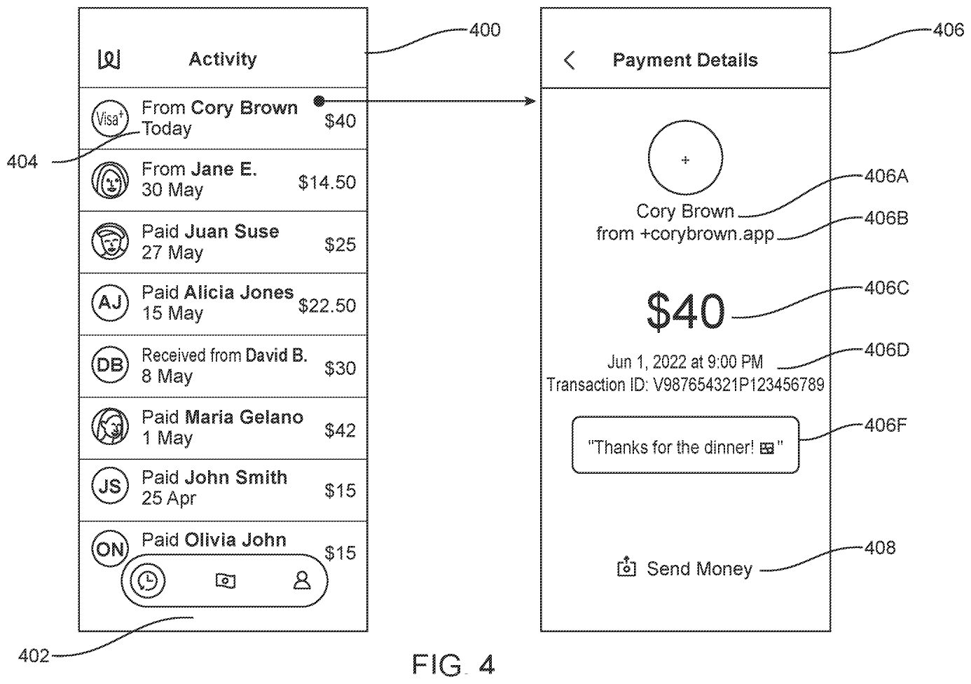

In step S226, the processing computer 210 can search for the supplemental data in its database from step S210 by matching the transaction data elements or the unique identifier in the push response message to the transaction data elements or the unique identifier stored in its database. For example, the payment token or payment credential, sender's digital tag, sender's reference number, an acquiring BIN and/or MVV, date and time of the transaction, etc. in the push transfer response message can be used to identify a match with corresponding transaction data stored by the processing computer 210 in step S210. The processing computer 210 may then identify and retrieve the corresponding supplemental data associated with the stored transaction data from the database. The processing computer 210 can then generate a notification message (e.g., an enhanced notification message) comprising the transaction data and the supplemental data. The processing computer 210 can then send the notification message to the second transfer application 214 without passing through the authorizing entity computer 222. In some embodiments, the second application provider server 226 may not support transmission of the supplemental data. The processing computer 210 sends the notification message to the second transfer application 214 bypassing the second application provider server 226 (e.g., the second digital server). The supplemental data is output on the second user device in connection with a notification associated with the transaction (further discussed below in connection with FIGS. 4-6.

In step S228, the transport computer 206 can notify the first transfer application 204 of the successful payment transfer. In step S230, the first transfer application 204 can notify the sender 202 of the successful payment transfer.

In step S232, the funds can be settled between the transport computer 206 and the authorizing entity computer 212 through a regular payment settlement (e.g., via the processing computer 160).

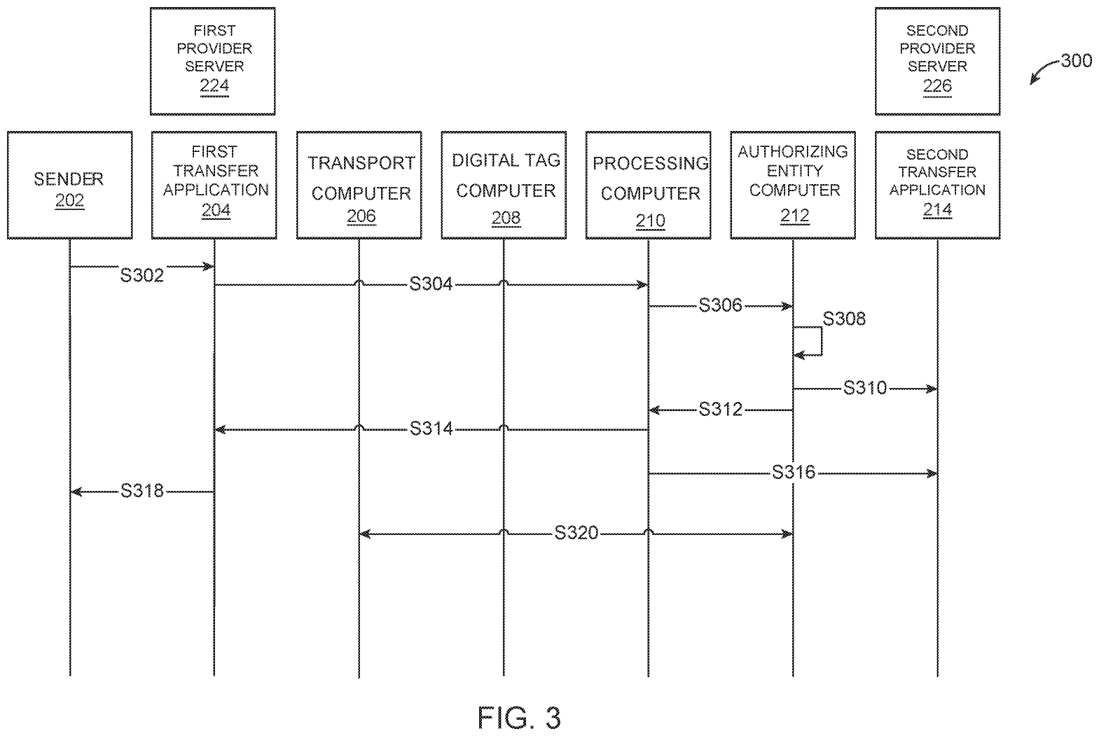

FIG. 3 illustrates a flow diagram of obtaining transaction data and supplemental data from a processing computer during a transaction, according to various embodiments.

The first transfer application 204 (e.g., digital wallet) may be associated (e.g., via API connectivity) with the processing computer 210. The first transfer application 204 provided on a first user device of the first user (e.g., sender 202) may be managed by a first application provider server 224. The second transfer application 214 (e.g., digital wallet) provided on a second user device of a second user (e.g., recipient) may be managed by a second application provider server 226.

In step S302, the sender 202 can initiate a person-to-person fund transfer by entering an account identifier (e.g., a digital tag, a payment token, an alias) of the recipient in the first transfer application 204 to send a payment to the recipient. The sender 202 may enter other transaction data such as transaction amount, and supplemental data such as a sender's note, an audio message, a video message, a multimedia message, a photo, etc.

In step S304, the first transfer application 204 can generate a transfer request message comprising transaction data (e.g., recipient's account identifier, transaction amount) and the supplemental data. The transfer request message may be in an API format. In some embodiments, the transfer request message may include an OCT request message transmitted using the API format. The transaction data may comprise a sender's account identifier, a sender's reference number, an acquirer's BIN and/or an MVV, a date and time of the transaction, etc. The supplemental data may include one or more of a text message, an audio file, a video file, a photograph, a multimedia file etc. that may be generated by the sender 202. The first transfer application 204 can send the transfer request message to the processing computer 210.

In step S306, the processing computer 210 can verify the transfer request message, and if necessary perform one or more of resolving the recipient's digital tag to obtain the payment token or payment credential linked to the digital tag, detokenizing the payment token to obtain the payment credential. The processing computer 210 may parse the transfer request message to identify one or more fields storing data. The processing computer 210 may identify a data field storing the supplemental data, and one or more fields storing the transaction data elements. The processing computer 210 may retrieve the supplemental data to store the supplemental data as being associated with the transaction data elements at the database. The processing computer 210 stores the transaction data elements and the supplemental data as being associated with the transaction data elements in the database.

Other digital tag payment processes can be found in PCT/US2021/030145, filed on Apr. 30, 2021, which is herein incorporated by reference in its entirety.

The processing computer 210 can generate the push request message using the OCT request message, excluding the supplemental data. The push request message may be in ISO format. In some embodiments, the push request message may be OCT authorization request message that does not include the supplemental data. The push request message may comprise the payment credential, the transaction data elements, but not the supplemental data due to size limitation and/or format requirements of the transfer request message. For example, the supplemental data may be too large to be stored in the ISO format. In fact, the ISO format may not include a data field configured to store the supplemental data. The processing computer 210 can send the push request message to the authorizing entity computer 212.

Optionally, in some embodiments, the processing computer 210 may also generate a unique identifier (e.g., transaction ID) associated with the transaction and the push request message. The push request message may comprise the unique identifier in addition to the payment credential, the transaction data elements, but not the supplemental data.

Steps S308 to S312 are similar to steps S218 to S222 of FIG. 2, and will not be repeated herein for brevity purposes.

In step S314, the processing computer 210 can generate a transfer response message comprising elements of the push response message. The transfer response message may be in API format. In some embodiments, the transfer response message may be OCT response message. The processing computer 210 can send the transfer response message to the first transfer application 204 to inform the first transfer application 204 of the successful transaction.

Steps S316 to S320 are similar to steps S226, S230, and S232 of FIG. 2 and will not be repeated herein for brevity purposes.

According to various embodiments, the supplemental data may be encrypted at the first transfer application, and transmitted to the processing computer. The processing computer may not be given the permission or ability to decrypt the supplemental data. Accordingly, the processing computer may store the supplemental data at the database in an encrypted form, and transmit the supplemental data to the second transfer application in the encrypted form. The first transfer application may share the decryption key with the second transfer application separately, or the second transfer application may be previously provided with the decryption key for communications received from the first transfer application. The second transfer application may decrypt the encrypted supplemental data using the decryption key, and output the decrypted supplemental data on the second user device.

In some embodiments, upon successful transmission of the supplemental data to the second transfer application, the processing server may delete the supplemental data from the database.

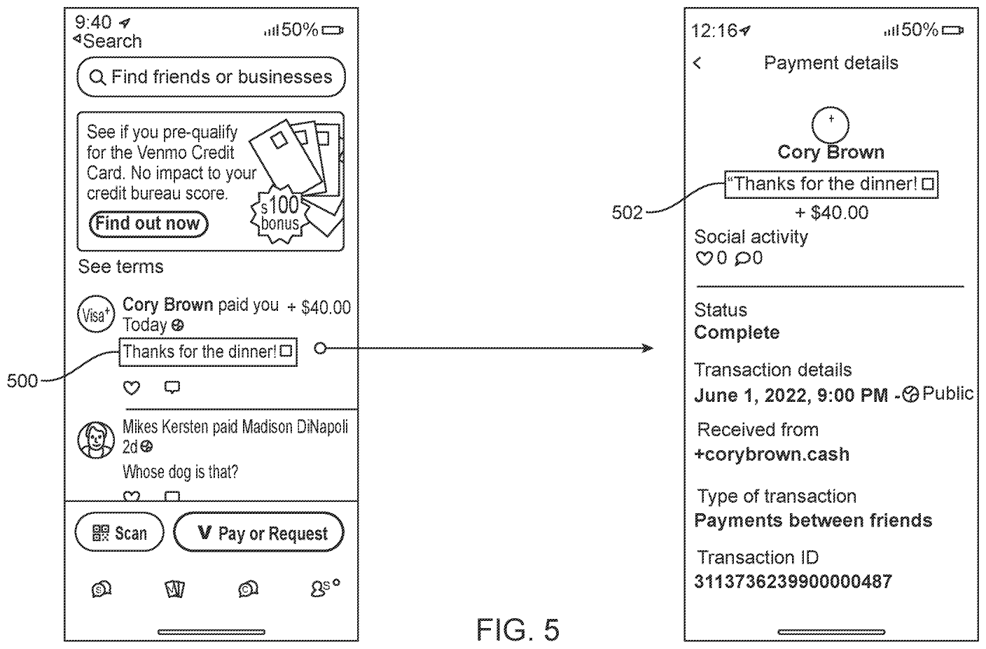

FIGS. 4-5 illustrate exemplary graphical user interfaces of a transfer application executing on a user device of a recipient, and outputting supplemental data in connection with a transaction, according to various embodiments.

As sown in FIG. 4, the payment application 400 executing on the user device 402 of the recipient may display a graphical user interface showing a list of transactions including funds received and sent by the user. The user may provide a user input to select one transaction 404 among the transactions to display additional information associated therewith. A second graphical user interface 406 may be displayed on the user device 402. The second graphical user interface 406 may include transaction elements such as an identity of the sender 406A, a first transfer application used by the sender to send the money 406B (which may be different than the payment application 400), an amount received 406C, the time and date of the transaction 406D. In addition, the payment application 400 may also output supplemental data received in connection with the selected transaction 404. For example, the supplemental data may be a text 406F or graphical art that may be displayed on the second graphical user interface 406. In some embodiments, the supplemental data may include an audio file, a video file or a multimedia file that may be played when the second graphical user interface 406 is displayed on the user device 402. The payment application 400 may be used to transfer funds and may include a widget 408 to start the transfer process.

FIG. 5 illustrates a set of graphical user interfaces that output the supplemental data 500, 502 in various layouts.

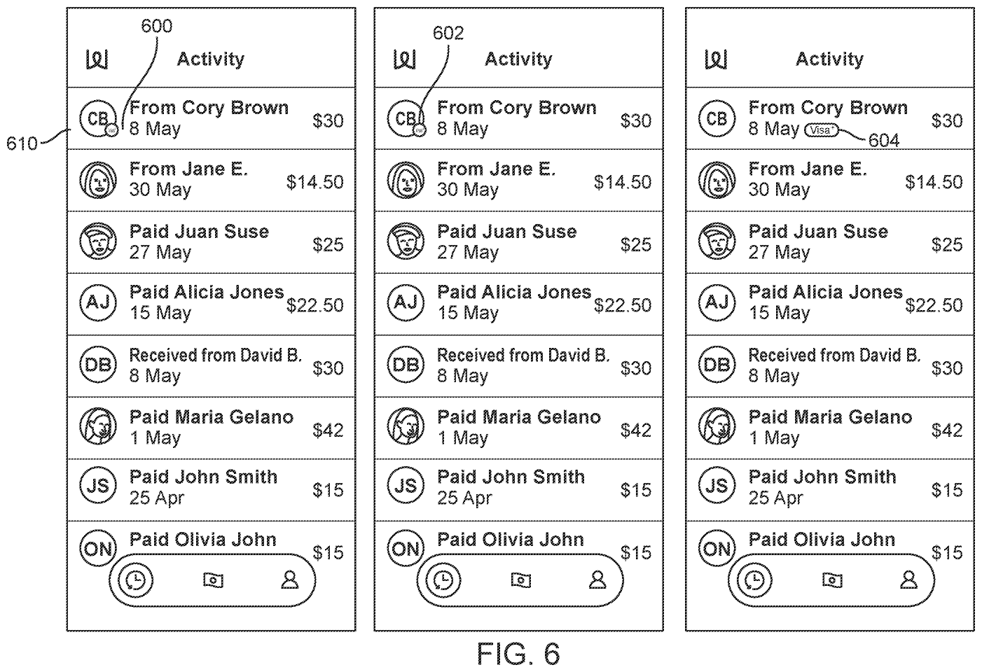

FIG. 6 illustrates an exemplary graphical user interface of a transfer application executing on a user device including exemplary visual cues for indicating supplemental data received in connection with a transaction, according to various embodiments. The visual cues indicate the presence of supplemental data in connection with a transaction displayed to the user as part of a list of transactions. For example, the graphical user interface may display a first transaction 610 showing a widget representing a sender, and a brief summary of the transaction. The widget may include a visual cue 600 indicating the presence of the supplemental data. Alternatively, the visual cue 604 may be displayed along with a summary of the transaction. Once the user selects the transaction, a second graphical user interface (as shown in FIG. 4 and FIG. 5) may be displayed showing all available transaction data and supplemental data associated with the transaction.

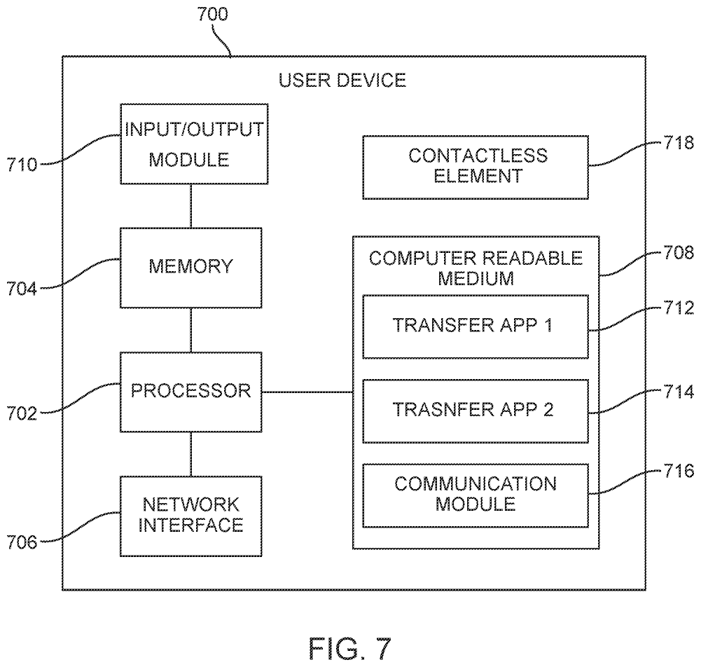

FIG. 7 illustrates a block diagram of an exemplary user device, according to various embodiments.

The user device 700 may include a processor 702 for processing functions of user device 700. The user device 700 may also include an input/output module 710 including elements such as a display, speakers, a vibration mechanism, a camera, a microphone, a touchscreen, a physical and/or digital keyboard, biometric sensors, etc. coupled to the processor 702. According to various embodiments, the input/output module 710 may be used to create the supplemental data described herein. The user device 700 may further comprise a volatile memory 704 (e.g., RAM, DRAM, EEPROM, etc.), a non-transitory computer readable medium 708, a network interface 706, and a contactless element 718 coupled to the processor 702.

The computer readable medium 708 may contain one or more applications (e.g., a first transfer application 712 and a second transfer application 714). Computer readable medium 708 may further contain a number of functional modules including an encryption module, a communication module, etc. The computer readable medium 708 may contain a communication module 716 that can include code, executable by the processor 702 to allow the user device 700 to communicate with other external devices.

The processor 702 may comprise any suitable data computation device or devices. Processor 702 may be able to interpret code and carry out instructions stored on computer readable medium 708. Processor 702 may comprise a Central Processing Unit (CPU) operating on a reduced instructional set, and may comprise a single or multi-core processor. Processor 702 may also include an Arithmetic Logic Unit (ALU) and a cache memory.

In some embodiments, the contactless element 718 may be implemented in the form of a semiconductor chip (or other data storage element) with an associated wireless transfer (e.g., data transmission) element, such as an antenna. Contactless element may be capable of transferring and receiving data using a short-range wireless communication capability (e.g., NFC).

The computer readable medium 708 may contain code, executable by the processor 702, for implementing the methods of embodiments. For example, the computer readable medium 708 may comprise code executable by the processor 702 for implementing a method comprising: receiving, by a first digital wallet application 712 executing on the user device 700 from a processing computer, a notification message comprising supplemental data and an outcome of a transfer transaction, wherein a provider server managing the first digital wallet is unable to support transmission of supplemental data; displaying, by the first digital wallet application 712, a graphical user interface to display the outcome of the transfer transaction; and outputting, by the first digital wallet application 712 in connection with input/output module 710 of the user device 700, the supplemental data along with displaying the outcome of the transfer transaction, wherein supplemental data comprises one or more of text data, image data, audio data, multimedia data, or data embedded in machine readable code.

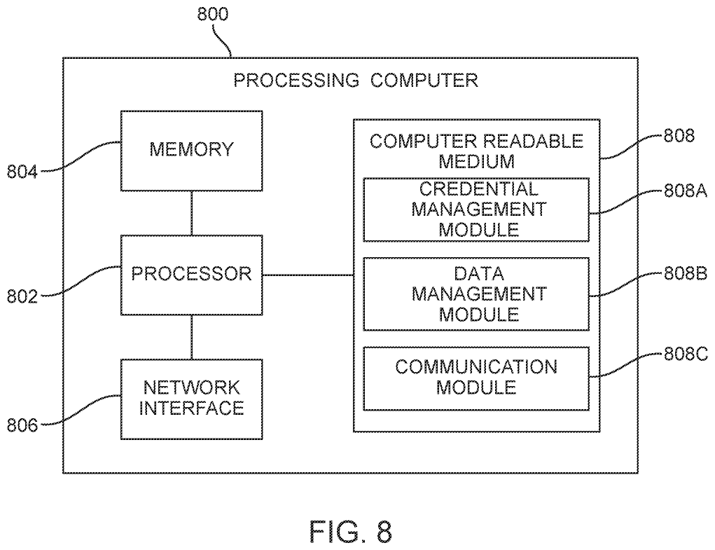

FIG. 8 illustrates a block diagram of an exemplary processing, according to various embodiments.

The processing computer 800 includes a processor 802 for processing the functions of the processing computer 800. The processing computer 800 may further comprise a network interface 806 that may include an interface that can allow the processing computer 800 to communicate with external devices (e.g., an access device, an acquirer computer, an authorizing entity, a transfer application executing on a user device), and which may be coupled to the processor 802. The processing computer 800 may further comprise a computer readable medium 808, which is coupled to the processor 802.

The computer readable medium 810 may contain a number of software modules. The modules may include a credential management module 808A, a data management module 808B, and a communication module 808C.

The credential management module 808A may comprise code, executable by the processor 802, to retrieve, convert and store account credentials including digital tags, credentials, real credentials, payment tokens.

The data management module 808B, may comprise functions or code executable by the processor 802, for parsing, identifying, storing, retrieving and matching supplemental data with transaction data received in messages associated with a transfer request.

The communication module 808C may comprise code, executable by the processor 802, to allow the processing computer 800 to communicate with other external entities.

The computer readable medium 808 may contain code, executable by the processor 802, for implementing the methods of embodiments. For example, the computer readable medium 808 may comprise code executable by the processor 802 for implementing a method comprising: receiving, from a digital wallet provided on a first user device, a processing request message comprising supplemental data and transaction data elements regarding a transaction between a first user operating the first user device and a second user operating a second user device; storing, in a database, the supplemental data as being associated with the transaction data elements; transmitting to an authorizing entity computer holding an account of the second user, a push request message comprising the transaction data elements without the supplemental data, wherein the push request message conforms to a format that the authorizing entity is configured to process; receiving, from the authorizing entity computer, a push response message comprising the transaction data elements; searching the database for the supplemental data using one or more of the transaction data elements received in the push response message; identifying the supplemental data in the database based on a match between the one or more of the transaction data elements received in the push response message with one or more of transaction data elements stored on the database; retrieving the supplemental data corresponding to matched transaction data elements; generating a notification message comprising the supplemental data; and transmitting the notification message comprising the supplemental data to a digital wallet provided on the second user device, wherein the supplemental data is output on the second user device in connection with a notification associated with the transaction.

The embodiments described above have a number of technical advantages. For example, embodiments allow transmission of supplemental data (e.g., arbitrary, user generated) data along with transaction data between different transfer applications. The supplemental data may include text data, audio data, video data, multimedia data, etc. The transmission of such supplemental data is a technical improvement because current peer-to-peer funds transfer applications are not able to transmit such data across their existing platforms. Cross-transfer applications transactions rely on ISO messages being exchanged. ISO messages, or any other fixed format type messages, do not have dedicated data fields for transporting supplemental data described herein. Embodiments provide a processing computer operating between the separate transfer applications that can retrieve and store the supplemental data until the transaction is processed, and fetch and reassociate the supplemental data with the transaction data prior to sending the enhanced notification (e.g., a notification including the transaction data as well as the supplemental data) directly to the transfer application executing on the recipient's device.

It should be understood that the present invention as described above can be implemented in the form of control logic using computer software (stored in a tangible physical medium) in a modular or integrated manner. Based on the disclosure and teachings provided herein, a person of ordinary skill in the art will know and appreciate other ways and/or methods to implement the present invention using hardware and a combination of hardware and software.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method comprising:
receiving, by a processing computer from a digital wallet provided on a first user device, a processing request message comprising supplemental data and transaction data elements regarding a transaction between a first user operating the first user device and a second user operating a second user device;
storing, by the processing computer in a database, the supplemental data as being associated with the transaction data elements;
transmitting, by the processing computer, to an authorizing entity computer holding an account of the second user, a push request message comprising the transaction data elements without the supplemental data, wherein the push request message conforms to a format that the authorizing entity computer is configured to process;
receiving, by the processing computer from the authorizing entity computer, a push response message comprising the transaction data elements;
searching, by the processing computer, the database for the supplemental data using one or more of the transaction data elements received in the push response message;
identifying, by the processing computer, the supplemental data in the database based on a match between the one or more of the transaction data elements received in the push response message with one or more of transaction data elements stored on the database;
retrieving, by the processing computer, the supplemental data corresponding to matched transaction data elements;
generating, by the processing computer, a notification message comprising the supplemental data; and
transmitting, by the processing computer, the notification message comprising the supplemental data to a digital wallet provided on the second user device, wherein the supplemental data is output on the second user device in connection with a notification associated with the transaction.

2. The method of claim 1, wherein the supplemental data comprises one or more of text data, image data, audio data, multimedia data, or data embedded in machine readable code.

3. The method of claim 1, wherein the digital wallet provided on the second user device is a second digital wallet managed by a second digital wallet server, wherein a first digital wallet provided on the first user device is managed by a first digital wallet server, wherein the first digital wallet server is different than the second digital wallet server.

4. The method of claim 3, wherein at least one of the first digital wallet server or the second digital wallet server is unable to support transmission of the supplemental data, and wherein transmission of the notification message comprising the supplemental data by the processing computer to the digital wallet provided on the second user device bypasses the second digital wallet server.

5. The method of claim 3, wherein the first digital wallet is a first transfer application provisioned on the first user device, and the second digital wallet is a second transfer application.

6. The method of claim 1, further comprising:
parsing, by the processing computer, the processing request message to identify one or more fields storing data;
identifying, by the processing computer, a data field storing the supplemental data; and
retrieving, by the processing computer, the supplemental data to store the supplemental data as being associated with the transaction data elements at the database.

7. The method of claim 1, further comprising:
storing, at a secure database by a digital tag computer in communication with the processing computer, a mapping between a digital tag of the second user and a credential associated with second user;
receiving, by the digital tag computer, the digital tag of the second user from the digital wallet provided on the first user device;
identifying, by the digital tag computer, the credential associated with second user at the secure database;
retrieving, by the digital tag computer, the credential associated with second user from the secure database; and
transmitting, by the digital tag computer, the credential associated with second user to the digital wallet provided on the first user device, wherein the transaction data elements received at the processing computer includes the credential associated with second user.

8. The method of claim 7, further comprising:
storing, at a secure database by a digital tag computer in communication with the processing computer, a first mapping between the digital tag of the first user and a first credential associated with the first user;
receiving, by the digital tag computer from the processing computer, the digital tag of the first user;
identifying, by the digital tag computer, the first credential at the secure database;
retrieving, by the digital tag computer, the first credential from the secure database; and
transmitting, by the digital tag computer, the first credential to the processing computer, wherein the transaction is settled using funds debited to an account associated with the first credential.

9. The method of claim 1, further comprising:
prior to transmitting, by the processing computer, the push request message to the authorizing entity computer:
transmitting, by the processing computer, a confirmation message to the digital wallet provided on the first user device confirming receipt of the supplemental data and the transaction data elements, wherein the confirmation message excludes the supplemental data, wherein the digital wallet provided on the first user device provides the transaction data elements to a transport computer, wherein the transport computer generates the push request message including the transaction data elements; and
receiving, by the processing computer, the push request message including the transaction data elements without the supplemental data from the transport computer.

10. The method of claim 1, further comprising:
generating, by the processing computer, a transfer response message; and
transmitting, by the processing computer, the transfer response message the digital wallet provided on the first user device, wherein the transfer response message is output on the first user device.

11. A system comprising:
a processing computer comprising one or more processors; and a non-transitory computer readable medium comprising code executable by the one or more processors for performing steps comprising:
receiving, from a digital wallet provided on a first user device, a processing request message comprising supplemental data and transaction data elements regarding a transaction between a first user operating the first user device and a second user operating a second user device;
storing, in a database, the supplemental data as being associated with the transaction data elements;
transmitting to an authorizing entity computer holding an account of the second user, a push request message comprising the transaction data elements without the supplemental data, wherein the push request message conforms to a format that the authorizing entity computer is configured to process;
receiving, from the authorizing entity computer, a push response message comprising the transaction data elements;
searching the database for the supplemental data using one or more of the transaction data elements received in the push response message;
identifying the supplemental data in the database based on a match between the one or more of the transaction data elements received in the push response message with one or more of transaction data elements stored on the database;
retrieving the supplemental data corresponding to matched transaction data elements;
generating a notification message comprising the supplemental data; and
transmitting the notification message comprising the supplemental data to a digital wallet provided on the second user device, wherein the supplemental data is output on the second user device in connection with a notification associated with the transaction.

12. The system of claim 11, wherein the supplemental data comprises one or more of text data, image data, audio data, multimedia data, or data embedded in machine readable code.

13. The system of claim 11, wherein the digital wallet provided on the first user device is associated with a first transfer application managed by a first application provider server, and the digital wallet provided on the second user device is associated with a second transfer application managed by a second application provider server, wherein the second transfer application is unable to support transmission of the supplemental data, and wherein transmission of the notification message comprising the supplemental data by the processing computer to the second transfer application bypasses the second application provider server.

14. The system of claim 11, wherein the code, when executed by the one or more processors of the processing computer, performs the steps further comprising:
parsing the processing request message to identify one or more fields storing data;
identifying a data field storing the supplemental data; and
retrieving the supplemental data to store the supplemental data as being associated with the transaction data elements at the database.

15. The system of claim 11, further comprising:
a digital tag computer in communication with the processing computer and another non-transitory computer readable medium comprising code executable by the digital tag computer for performing:
storing, at a secure database, a mapping between a digital tag of the second user and a credential associated with second user;
receiving the digital tag of the second user from the digital wallet provided on the first user device;
identifying the credential associated with second user at the secure database;
retrieving the credential associated with second user from the secure database; and
transmitting the credential associated with second user to the digital wallet provided on the first user device, wherein the transaction data elements received at the processing computer includes the credential associated with second user.

16. The system of claim 15, wherein the code executable by the digital tag computer further performs:
storing, at a secure database, a mapping between the digital tag of the first user and a first credential associated with the first user;
receiving, from the processing computer, the digital tag of the first user;
identifying the first credential at the secure database;
retrieving the first credential from the secure database; and
transmitting the first credential to the processing computer, wherein the transaction is settled using funds debited to an account associated with the first credential.

17. The system of claim 11, wherein the code, when executed by the one or more processors of the processing computer, performs the steps further comprising:
prior to transmitting the push request message to the authorizing entity computer:
transmitting a confirmation message to the digital wallet provided on the first user device confirming receipt of the supplemental data and the transaction data elements, wherein the confirmation message excludes the supplemental data, wherein the digital wallet provided on the first user device provides the transaction data elements to a transport computer, wherein the transport computer generates the push request message including the transaction data elements; and
receiving the push request message including the transaction data elements without the supplemental data from the transport computer.

18. The system of claim 11, wherein the code, when executed by the one or more processors of the processing computer, performs the steps further comprising:
generating a transfer response message; and
transmitting the transfer response message the digital wallet provided on the first user device, wherein the transfer response message is output on the first user device.

19. A method comprising:
receiving, by a first digital wallet application executing on a first user device from a processing computer, a notification message comprising supplemental data and an outcome of a transfer transaction, wherein a digital wallet provider server managing the first digital wallet application is unable to support transmission of supplemental data;
displaying, by the first digital wallet application, a graphical user interface to display the outcome of the transfer transaction; and
outputting, by the first digital wallet application, the supplemental data along with displaying the outcome of the transfer transaction, wherein supplemental data comprises one or more of text data, image data, audio data, multimedia data, or data embedded in machine readable code.

20. The method of claim 19, further comprising:
receiving, by the first digital wallet application, a user input selecting the transfer transaction;
retrieving, by the first digital wallet application, additional information associated with the transfer transaction from the digital wallet provider server managing the first digital wallet application;
displaying, by the first digital wallet application, a subsequent graphical user interface to display the additional information received from the digital wallet provider server managing the first digital wallet application; and
outputting, by the first digital wallet application, the supplemental data received from the processing computer along with displaying the additional information received from the digital wallet provider server managing the first digital wallet application.
